(19) United States
(12) Patent Application Publication
(10) Pub. No.: US 2017/0226410 A1
(43) Pub. Date: Aug. 10, 2017

(54) Proppant Material Incorporating Fly Ash and Method of Manufacture

(71) Applicant: EPROPP, LLC, New York, NY (US)

(72) Inventors: Ralph Enderle, Nuremberg (DE); Natalia Schwamm, Fuerth (DE)

(21) Appl. No.: 15/488,631

(22) Filed: Apr. 17, 2017

Related U.S. Application Data
(63) Continuation-in-part of application No. 15/409,782, filed on Jan. 19, 2017.
Application No. 15/409,782 is a continuation of application No. 13/971,287, filed on Aug. 20, 2013, now Pat. No. 9,587,170.

(51) Int. Cl. C09K 8/80; C04B 41/45

(52) U.S. Cl. CPC C09K 8/805; C04B 41/4543; C04B 41/4545

(57) ABSTRACT

A method of manufacturing a round proppant material includes forming round granules comprising fly ash and clay, wherein the fly ash is the primary component by weight, adding a separating agent to the round granules, calcining the round granules at a temperature in a range between 900° C. and 1150° C., and sintering the round granules at a temperature in a range between 1050° C. and 1350° C.

### CROSS-REFERENCE TO RELATED APPLICATIONS

This application is a continuation-in-part of U.S. patent application Ser. No. 15/409,782, filed on Jan. 19, 2017, which is a continuation of U.S. patent application Ser. No. 13/971,287, filed on Aug. 20, 2013, which issued as U.S. Pat. No. 9,587,170 on Mar. 7, 2017, all of which are hereby incorporated by reference in their entirety.

### BACKGROUND OF THE INVENTION

Hydraulic fracturing is the fracturing of various rock layers by a pressurized liquid. This is useful in oil and gas operations, as the fractures created by the hydraulic fracturing can serve as enhanced flow paths to the well for oil or gas trapped in rock formations. However, once the fractures have been created, they must be “propped” open by some means because otherwise the fractures will close when the pressure from the high pressure liquid used to create the fractures is relieved.

Crush resistant particles, referred to as “proppant”, may be pumped into the fractures after they have been created to hold the fractures open. It is desirable that such proppant materials be both very crush resistant (so that the forces exerted on them by the fractures as they try to close do not crush them, which would permit the fractures to close) and have a relatively low specific gravity (so that they may be transported easily into the fractures by a fluid pumped into the well). These two properties often can be somewhat at odds with each other, because an increase in crush resistance typically tends to result in a material being more dense.

Because proppant materials typically are sold by weight rather than by volume, a proppant material having a relatively low density will actually have a lower effective cost to the user even if it is sold at the same price per pound as a more dense proppant material. It is also desirable that the proppant particles be relatively spherical to maximize the spaces between proppant particles and the ease with which fluids will flow through such spaces. Depending on the proppant material, crushing of proppant particles can result in the creation of many very fine particles which could block some of the spaces between the remaining larger proppant particles, reducing the ability of fluids to flow through those spaces. Accordingly, it is desirable that, when the crush strength of the proppant material is exceeded, the proppant particles break into a few relatively large fragments rather than become pulverized. Depending on the application, different sizes of proppant particles may be used, although it is desirable that the proppant particles be of a relatively uniform size.

Bauxite is a common aluminum ore. Bauxite is composed primarily of one or more aluminum hydroxide minerals, plus various mixtures of silica (SiO₂), iron oxide (Fe₂O₃), titania (TiO₂), aluminosilicate, and other impurities in minor amounts. Sintered bauxite has been used in the past as a proppant material because particles made essentially from bauxite, when sintered, form a relatively hard, crush resistant material. However, bauxite has a relatively high specific gravity and sintered bauxite is considered a relatively heavy-weight (i.e., higher density) ceramic proppant material. Moreover, the quality requirements for bauxite used to make a sintered bauxite proppant material are very strict in order to provide the required strength. There are only a relatively few sources of bauxite that are suitable for producing a sintered bauxite proppant material because of the impurities present in most bauxites.

### BRIEF SUMMARY OF THE INVENTION

According to one aspect of one or more embodiments of the present invention, a round proppant material includes a core where the core is made of fly ash and clay, wherein the fly ash is the primary component by weight. A separating agent is applied to the core during manufacture.

According to one aspect of one or more embodiments of the present invention, a method of manufacturing a round proppant material includes forming round granules comprising fly ash and clay, wherein the fly ash is the primary component by weight, adding a separating agent to the round granules, calcining the round granules at a temperature in a range between 900° C. and 1150° C., and sintering the round granules at a temperature in a range between 1050° C. and 1350° C.

According to one aspect of one or more embodiments of the present invention, a round proppant material includes a core that is made of fly ash, bauxite, and clay, wherein the fly ash is the primary component by weight. A separating agent is applied to the core during manufacture.

According to one aspect of one or more embodiments of the present invention, a method of manufacturing a round proppant material includes forming round granules comprising fly ash, bauxite, and clay, wherein the fly ash is the primary component by weight, adding a separating agent to the round granules, calcining the round granules at a temperature in a range between 900° C. and 1150° C., and sintering the round granules at a temperature in a range between 1050° C. and 1350° C.

Other aspects of the present invention will be apparent from the following description and claims.

### DETAILED DESCRIPTION OF THE INVENTION

One or more embodiments of the present invention are described in detail. In the following detailed description of the invention, specific details are set forth in order to provide a thorough understanding of the invention. In other instances, well-known features to one of ordinary skill in the art are not described to avoid obscuring the description of the invention.

Embodiments described herein generally relate to proppant materials which may be used in hydraulic fracturing operations in oil and gas wells, and methods of manufacturing the same.

Specifically, one or more embodiments of the present invention relate to light-weight (i.e., lower density) ceramic proppant materials made primarily from fly ash. Fly ash comprises the fine particles that rise with the flue gases, and in industrial applications, usually refers to ash particles produced during the combustion of coal. The components of fly ash vary considerably, but all fly ash includes substantial amounts of silicon dioxide (SiO₂) and, in some cases, substantial amounts of calcium oxide (CaO), ferric oxide (Fe₂O₃), and/or aluminum oxide (Al₂O₃) which are components of many coal-bearing rock strata. Other components of the fly ash depend upon the specific coal bed makeup.

An advantage of using fly ash in embodiments of the present invention is that fly ash has a relatively low density compared to bauxite, the specific gravity of which may vary from about 2.5 to 3.5, depending on its specific composition, while the specific gravity of fly ash may vary from about 2.0 to 2.5. Another advantage of using fly ash in embodiments of the present invention is that the disposal of fly ash has become problematic with significant environmental implications, making opportunities for the recycling of fly ash desirable. Currently, most fly ash produced from coal-fired power stations is disposed of in landfills and ash ponds. The single largest recycling use at present for fly ash is to replace a portion of the Portland cement content in concrete. Advantageously, the present invention permits recycling of fly ash waste into a material that is useful in hydraulic fracturing operations in oil and gas wells.

While fly ash has been proposed to be used as a component of a proppant material, past efforts to make a commercially successful ceramic proppant material containing a significant amount of fly ash have failed. The aggregate formed by sintering briquettes of fly ash containing materials and then crushing the briquettes and screening the crushed particles to obtain suitable sized particles is not satisfactory for use as a proppant material. The shapes of the particles formed by crushing are so irregular that they are not sufficiently spherical to make a good proppant material and the irregular shapes of the particles also reduces their crush resistance.

U.S. Pat. No. 7,828,998 discloses making proppant from granules made from kaolinite, bauxite, fly ash, and combinations thereof. However, in U.S. Pat. No. 7,828,998, the granules are heated initially under reducing conditions so that at least part of the metal oxide dopant is reduced to form a metastable, transient liquid phase among the particles. This liquid phase includes at least part of the reduced metal oxide dopant, promotes sintering among the particles, and forms islands of reduced metal oxide dopant within and on the surface of the granules. Following the heating under reducing conditions, the granules are heated under oxidizing conditions such that the islands of reduced metal oxide are oxidized and/or go into solid solution within the particles, thereby creating voids within and forming a metal or metal oxide shell on the granules. Advantageously, in one or more embodiments of the present invention, methods of manufacture do not require heating the granules under reducing conditions followed by heating the granules under oxidizing conditions.

Other prior art has created relatively low density proppant materials which required the use of nano-scale raw materials. Using feedstocks with a nano-scale particle size greatly increases the cost of the feedstocks and the finished product to non-economic levels. Advantageously, in one or more embodiments of the present invention, methods of manufacture do not require the use of raw materials smaller than d90<10μ (90% of the particles are less than 10μ in size).

Accordingly, in one or more embodiments of the present invention, a spherical or round proppant material, which has a low density and is suitably crush resistant to serve as a proppant, may be made by sintering spherical or round granules formed from a mixture of fly ash and clay or a mixture of fly ash, clay, and bauxite, in which fly ash is the primary component by weight. While the descriptive terms “spherical” or “round” are used herein, it is understood that the granules formed will not necessarily be perfect spheres, but instead will be sphere-like, i.e., well rounded where the major and minor axes of the granule are approximately the same, but not necessarily exactly the same. In other words, the “spheres” or “round” granules may be slightly elliptical or otherwise deviate from being perfect spheres, but will be very well rounded and approximately spherical.

The clay content acts as a plasticizer to promote formation of the desired granules and provide them with a measure of physical stability prior to the sintering of the granule. In the embodiments discussed in detail below, kaolin clay is used, however, one of ordinary skill in the art will recognize that ball clay, illite, or any other clay materials with suitable characteristics may be used.

In embodiments that include bauxite, the bauxite need not be of such a high quality. In conventional sintered bauxite proppants, very high quality bauxite is required because they must be sintered at very high temperatures, such as, for example, 1400° C. to 1600° C. If there are sufficient impurities in the bauxite, when sintering at such high temperatures, the impurities melt thereby ruining the proppant. However, in one or more embodiments of the present invention, lesser quality, and therefore less expensive, bauxite may be used because the present invention only requires that the bauxite avoid melting on the outside of the proppant to avoid sticking at the lower sintering temperatures used. Advantageously, this allows for the use of less expensive bauxite that is readily available from more sources.

The granules formed may be calcined by heating the granules to a calcination temperature that removes water and other volatile materials otherwise contained in the granules. Then, to obtain the desired degree of crush resistance, the granules are sintered at a temperature above what will cause granules to become very sticky as a result of melting of some of the components of the materials in the mixture, particularly one or more of the components of, including impurities in, the fly ash. If the granules become too sticky during the sintering step, they will agglomerate, which results in a poor yield of uniformly sized particles of a specific size. Moreover, excessive stickiness will cause the granules to adhere to the kiln in which they are being sintered, reducing the yield and damaging the kiln.

To prevent excessive stickiness on the surface of the granules when heated to sintering temperatures, the granules are separated by adding a separating agent, such as, for example, a suitable dry powder, prior to, or during, sintering that obviates the stickiness problem. The separating agent may be added either before or after the calcining process, but must be added before, or during, the sintering process. In certain embodiments, the separating agent may be added just before placing the granules in the kiln. In other embodiments, the separating agent may be added during sintering directly in the kiln. In still other embodiments, the separating agent may be added directly after granulation.

Advantageously, in one or more embodiments of the present invention, a spherical or round proppant material provides high crush resistance, is low density, and is relatively inexpensive to manufacture. In addition, when a proppant particle associated with this invention fails, it tends to fracture into a relative few, large pieces rather than become pulverized.

One of ordinary skill in the art will recognize that the composition of the raw materials, including the nature and the amounts of various impurities which naturally occur in the raw materials, may affect the relative proportions of the raw materials used and may require appropriate adjustments to the times and amounts of water added to form satisfactory granules.

Similarly, the chemical composition of different fly ashes may be substantially different. Fly ash with excessively high iron oxide content can present economically insurmountable problems because of the degree of stickiness which results. Best results were achieved with fly ash having an iron oxide content of about 4%. Using a fly ash containing in excess of 12% iron oxide can caused insurmountable problems of sticking in the kiln. Accordingly, iron oxide content in the fly ash should be less than 12%, preferably about 7% or less, and most preferably about 4% or less.

Fly ash from the combustion of various types of coal (e.g., lignite, bituminous, and anthracite coals) may be used to make proppant materials. Lignite fly ash typically contains a much higher proportion of CaO (and therefore smaller proportions of SiO₂ and Al₂O₃) than bituminous or anthracite fly ash. In certain embodiments, very strong proppant materials may be made from fly ash and clay without any bauxite or coating. In other embodiments, very strong proppant materials may be made from fly ash, clay, and bauxite with minimal bauxite content and without coating.

Prior to mixing, the fly ash and clay of certain embodiments or the fly ash, clay, and bauxite of other embodiments are in powdered form, as described below. In one embodiment, the specifications for the fly ash, the clay, and the bauxite are as shown in Tables 1, 2, and 3, respectively (it is recognized that the total % may be slightly more or less than 100%—this is the result of rounding of some of the values in the table):

TABLE 1
Fly Ash

| Compound | % |
|---|---|
| SiO₂ | 66.0 |
| Al₂O₃ | 22.6 |
| Fe₂O₃ | 4.0 |
| TiO₂ | 0.6 |
| K₂O | 2.5 |
| MgO | 0.2 |
| Na₂O | 0.3 |
| CaO | 0.3 |
| SO₃ | 0.2 |
| LOI | 5.2 |

TABLE 2
Clay (Kaolin)

| Compound | % |
|---|---|
| SiO₂ | 59.78 |
| Al₂O₃ | 25.84 |
| Fe₂O₃ | 1.86 |
| CaO | 0.39 |
| MgO | 0.54 |
| K₂O | 2.08 |
| Na₂O | 0.38 |
| LOI_{1000° C.} | 7.28 |

TABLE 3
Bauxite

| Compound | Mass % |
|---|---|
| Al₂O₃ | 86 min |
| SiO₂ | 8 max |
| Fe₂O₃ | 2 max |
| TiO₂ | 4 max |
| K₂O + Na₂O | 0.3 max |
| CaO + MgO | 0.6 max |

One of ordinary skill in the art will recognize that the above noted specifications for the dry ingredients may vary based on their source and quality. The fly ash and the bauxite both may be ground to d90<10μ. In certain embodiments, the clay may be ground to d90<20μ. In other embodiments, the clay may be ground to d90<12μ. One of ordinary skill in the art will recognize that the grinding of the clay may vary based on the type and kind of clay in accordance with one or more embodiments of the present invention.

The dry ingredients used in certain embodiments described below and their respective percentages of the total are set forth in Table 4A and Table 4B below. Specifically, Table 4A provides approximate percentages of dry ingredients for certain embodiments where the core comprises fly ash and clay (and does not include bauxite). One of ordinary skill in the art will recognize that the approximate values shown in Table 4A may vary somewhat based on an application or design and still be within the scope of the present invention.

TABLE 4A
Dry Ingredients

| Material | Weight (g) | % Core | % Total |
|---|---|---|---|
| Fly Ash | 1,522 | 90% | 90% |
| Clay | 326 | 10% | 10% |

Similarly, Table 4B provides approximate percentages of dry ingredients for other embodiments where the core comprises fly ash, clay, and bauxite. One of ordinary skill in the art will recognize that the approximate values shown in Table 4B may vary somewhat based on an application or design and still be within the scope of the present invention.

TABLE 4B
Dry Ingredients

| Material | Weight (g) | % Core | % Total |
|---|---|---|---|
| Fly Ash | 1,522 | 70% | 70% |
| Clay | 326 | 15% | 15% |
| Bauxite | 350 | 15% | 15% |

In certain embodiments discussed herein, granulation is accomplished using an Eirich R02 mixer (with the pin tool). However, it is understood that other high shear granulating mixers or other granulating/pelletizing mixers or technologies may be used to form the granules, with appropriate adjustments to the times and amounts of water added to form satisfactory granules. One of ordinary skill in the art will recognize that other mixers or equipment, having other tools and settings, may be used for such embodiments and still be within the scope of the present invention.

The specifications for the tools and settings on the Eirich R02 mixer are shown in Table 5 below. Specifically, Table 5 provides the specification for the tools and settings on the Eirich R02 mixer for certain embodiments where the core comprises fly ash and clay (and does not include bauxite) and other embodiments where the core comprises fly ash, clay, and bauxite. One of ordinary skill in the art will recognize that other mixers or equipment, having other tools and settings, may be used for such embodiments and still be within the scope of the present invention.

TABLE 5
Mixer Specifications/Settings

| | |
|---|---|
| Granulation tool 1 - diameter | 0.136 m |
| Granulation tool 2 - diameter (Pin Type) | 0.136 m |

| Rotor | A | B | C |
|---|---|---|---|
| V-belt setting | | | |
| Rotational speed - Level 1 [rpm] | 900 | 1500 | 2500 |
| Rotational speed - Level 2 [rpm] | 1800 | 3000 | 5000 |
| Rim speed [m/s] | | | |
| Level 1 | 6.41 | 10.68 | 17.80 |
| Level 2 | 12.82 | 21.36 | 35.60 |

The protocol for granulation of the raw materials involves granulation of the raw ingredients plus water to form the granules. An additional step of finishing granules to enhance roundness also may be desirable. In some embodiments, it is suitable to add fly ash, clay, or other dry powder during the granulation process. By adding dry powder, the surface of the wet granules become dry and therefore the granules do not grow during extended time of rounding.

The protocol for granulation of raw materials is shown in Table 6A and Table 6B below. Specifically, Table 6A shows the protocol for granulation of raw materials for certain embodiments where the core comprises fly ash and clay (and does not include bauxite).

TABLE 6A
Protocol for Formation of Granules

| | | | Rim Speed | | Mixing | | Water | |
|---|---|---|---|---|---|---|---|---|
| | Settings | | [m/s] | | Principle | | Addition | |
| Step | Rotor | Pan | Rotor | Pan | [ccf/cf] | Step Description | (g) | Time [s] |
| 1 | C1 | 2 | 17.80 | 2 | ccf | Dry mix | 0 | 60 |
| 2 | C1 | 2 | 17.80 | 2 | ccf | Water addition for | 380 | 15 |
| | | | | | | reducing dust | | |
| 3 | C2 | 2 | 35.60 | 2 | ccf | Water addition at high | | 90 |
| | | | | | | speed for forming | | |
| | | | | | | microgranules | | |
| 4 | C2 | 2 | 35.60 | 2 | ccf | Microgranulation | 0 | 60 |
| 5 | B2 | 2 | 21.36 | 2 | ccf | High speed for forming | 0 | 60 |
| | | | | | | microgranules | | |
| 6 | A2 | 2 | 12.82 | 2 | ccf | Rounding of the | 0 | 60 |
| | | | | | | microgranules | | |

The dry, powdered raw materials (fly ash and clay) for the granule cores are combined in the mixer (step 1). In this embodiment, the followings amounts of the powdered raw materials were added to the mixer in step 1: fly ash-1.98 kg. and kaolin clay-0.22 kg. This will result in the granule cores being about 90% fly ash, and about 10% clay. Water is added smoothly as a spray to the powdered raw materials as they are mixed to form a cohesive material (steps 2-3). The water is preferably added in two steps to minimize dust escaping from the mixer—a small amount of water is added at first with the mixer at low speed until the raw materials have been wetted, and the remainder is added with the mixer at higher speed. After the raw materials and water have been mixed, the core granules are formed in the mixer (step 4). The microgranules are formed from the raw material and water mixture. The microgranules are then grown to the desired size (step 5). In some embodiments, it may be desired to finish the coated granules in the mixer to further enhance roundness (step 6).

Table 6B shows the protocol for granulation of raw materials for certain embodiments where the core comprises fly ash, clay, and bauxite.

TABLE 6B
Protocol for Formation of Granules

| | | | Rim Speed | | Mixing | | Water | |
|---|---|---|---|---|---|---|---|---|
| | Settings | | [m/s] | | Principle | | Addition | |
| Step | Rotor | Pan | Rotor | Pan | [ccf/cf] | Step Description | (g) | Time [s] |
| 1 | C1 | 2 | 17.80 | 2 | ccf | Dry mix | 0 | 60 |
| 2 | C1 | 2 | 17.80 | 2 | ccf | Water addition for | 380 | 15 |
| | | | | | | reducing dust | | |
| 3 | C2 | 2 | 35.60 | 2 | ccf | Water addition at high | | 90 |
| | | | | | | speed for forming | | |
| | | | | | | microgranules | | |
| 4 | C2 | 2 | 35.60 | 2 | ccf | Microgranulation | 0 | 60 |
| 5 | B2 | 2 | 21.36 | 2 | ccf | High speed for forming | 0 | 60 |
| | | | | | | microgranules | | |
| 6 | A2 | 2 | 12.82 | 2 | ccf | Rounding of the | 0 | 60 |
| | | | | | | microgranules | | |

The dry, powdered raw materials (fly ash, clay, and bauxite) for the granule cores are combined in the mixer (step 1). In this embodiment, the followings amounts of the powdered raw materials were added to the mixer in step 1: fly ash-1,522 g.; clay-326 g.; and bauxite-350 g. This will result in the granule cores being about 70% fly ash, about 15% clay, and about 15% bauxite. Water is added smoothly as a spray to the powdered raw materials as they are mixed to form a cohesive material (steps 2-3). The water is preferably added in two steps to minimize dust escaping from the mixer—a small amount of water is added at first with the mixer at low speed until the raw materials have been wetted, and the remainder is added with the mixer at higher speed. After the raw materials and water have been mixed, the core granules are formed in the mixer (step 4). The microgranules are formed from the raw material and water mixture. The microgranules are then grown to the desired size. (step 5). In some embodiments, it may be desired to finish the coated granules in the mixer to further enhance roundness (step 6).

The protocol described in Tables 6A and 6B is suitable for making proppants in the range of 20-50 mesh, but with appropriate modifications can be used to make proppant materials in the range of 16-30 mesh, 40-70 mesh, or even smaller than 40-70 mesh; pretty much any commercially desired size range is feasible. The residual moisture content after granulation in this particular embodiment is in the range of 9-12 Ma. %. It is understood that the targeted residual moisture content may vary depending on the composition of feedstocks used, including the relative proportions of the feedstocks and their individual specifications (e.g., constituent components and impurities, particle size, etc.). Generally, the residual moisture content should be in the range of 5-20 Ma. %, and preferably in the range of 7-15 Ma. %. By relatively small changes in the moisture content, temperature, and the time allotted to growth of the microgranules, different particle size distributions can be achieved. One of ordinary skill in the art will recognize that the granulation process may be adjusted depending on characteristics of the raw materials used in accordance with one or more embodiments of the present invention.

For up-scaling of the process, it is helpful to properly control the rim speed of the granulation tools used. Especially during the first part of the granulation process, it is essential to use a higher rim speed to form microgranules with a good particle size distribution. These microgranules can then be grown to very round granules later using a lower rim speed. Rim speed during the different steps is shown in Tables 6A and 6B.

After creating microgranules with a good size distribution, the rim speed of the rotor should be decreased to ensure proper growth of the granules. The speed of the rotor still needs a relatively high value to ensure good distribution. If the speed is too low, large lumps can be formed on the granules which can result in a bad distribution and a poor yield. Growth of the granules continues until the granules have reached the desired size. At this point, the granules are the proper size, but are not very well rounded.

To better round the granules, the rotor speed is reduced and the granules are rounded for a relatively brief period of time. The time should be as short as possible, but as long as necessary to get reasonably round granules. If the time is too long, the granules will start to grow again at the low rotor speed.

Once granulation is complete, the granules may be calcinated in suitable kiln, such as a rotary kiln, at a temperature of about 900° C.-1150° C., preferred 950° C.-1150° C., more preferred 1050° C.-1080° C. for about 2-60 minutes, preferably 10-30 minutes, or most preferably 15-20 minutes. The temperature of a rotary kiln typically is somewhat higher than the actual sintering temperature in the sintering bed inside the kiln tube (which may be read by a thermocouple), so the kiln temperature may be on the order of about 1050° C.-1350° C., depending on the kiln. Calcination of the material at too high a temperature (or to the correct temperature too fast) could result in the crystalline water and other volatile materials being released too fast, which could lead to cracks in the green material which in turn would weaken the structure of the proppant material and limit its maximum strength.

After calcinating at suitable temperature the granules may be powdered with a separating agent such as, for example, a dry powder, and mixed smoothly. In certain embodiments, the separating agent may be added after calcinating, but prior to sintering. However, in other embodiments, the separating agent may be added before calcinating. And in still other embodiments, the separating agent may be added during sintering. One of ordinary skill in the art will recognize that the separating agent may be added at different stages of the process based on an application or design in accordance with one or more embodiments of the present invention.

In certain embodiments, the separating agent may comprise bauxite. In other embodiments, the separating agent may comprise mullite. In still other embodiments, the separating agent may comprise any other suitable high temperature resistant material. One of ordinary skill in the art will recognize that other separating agents may be used within the scope of the present invention. It is understood that the targeted amount of separating agent may vary depending on the composition of feedstocks used, including relative portions of the feedstocks and their individual specifications (e.g., constituent components and impurities, particle size, etc.). The amount of powder necessary to avoid sticking of the granules (to the kiln and each other) is about 1-12 Ma. %, preferred 1-8 Ma. %, and more preferred 2-4 Ma. %. However, one of ordinary skill in the art will recognize that other amounts may be added based on an application or design in accordance with one or more embodiments of the present invention.

The calcined and powdered granules may then be sintered in a suitable kiln, such as a rotary kiln, at a temperature of about 1050° C.-1350° C., preferred 1150° C.-1300° C., and more preferred 1200° C.-1280° C. (again, the kiln temperature may be somewhat higher than the sintering temperature in the sintering bed). The sintering temperature may vary based on the type of fly ash and raw material used. For certain lignite fly ash, the sintering temperature may be as low as 1050° C. For other types of fly ash, the sintering temperature may be as high as 1350° C. In certain embodiments where core granules are formed from a mixture of fly ash and clay, the addition of the separating agent prior to sintering allows for a maximum sintering temperature of about 1240° C.-1280° C. without significant sticking of the granules to each other during sintering (again, the kiln temperature may be somewhat higher that the sintering temperature in the sintering bed, which may be on the order of about 1380° C., depending on the kiln). Similarly, in other embodiments where core granules are formed from a mixture of fly ash, clay, and bauxite, the addition of the separating agent prior to sintering allows for a sintering temperature of about 1240° C.-1280° C. without significant sticking of the granules to each other during sintering (again, the kiln temperature may be somewhat higher that the sintering temperature in the sintering bed, which may be on the order of about 1380° C., depending on the kiln).

It is understood that the calcination and the sintering steps described above may be performed in separate kilns or in different sections of the same kiln as the material passes through the kiln. When calcination and sintering steps are performed in one kiln, the sample may be powdered before placement in kiln or in the kiln itself

For proppant made using lignite fly ash, the sintering temperature may be lower. For example, if lignite fly ash is used, a combination calcination/sintering step may be used at a temperature of about 1080° C.-1100° C.

If a rotary kiln is used, there may be a small amount of sticking to the kiln tube, but it should not be excessive.

After the sintering process, the separating powder may be removed from the surface by sieving the sintered granules/proppants to the desired particle size. During the sieving process about 80% of the separating powder may be recovered and reused for powdering again. For the sieving process, a state of the art vibrating sieve with a suitable mesh size may be used.

In certain embodiments where the core comprises fly ash and clay, crush testing of the proppant material produced in the manner described above indicated a compressive strength in excess of 6,000 pounds per square inch (“psi”), however, lab results produced compressive strength in excess of 11,000 psi during some tests. Compressive strength of the proppant material is dependent to a large degree on particle size. The embodiment described above achieved a compressive strength in excessive of 11,000 psi for 30/50 mesh proppant material.

In certain embodiments where the core comprises fly ash, clay, and bauxite crush testing of the proppant material produced in the manner described above indicated a compressive strength in excess of 10,000 pounds psi. Compressive strength of the proppant material is dependent to a large degree on particle size. The embodiment described above achieved a compressive strength in excessive of 11,000 psi for a 30/50 mesh proppant material.

Advantages of one or more embodiments of the present invention may include one or more of the following:

In one or more embodiments of the present invention, a round proppant material having a core comprising fly ash and clay, wherein the fly ash is the primary component by weight, provides a proppant material that does not require a coating. The proppant may be manufactured by granulating the particles, drying the granules, sieving the granules and, prior to entering the kiln, adding a separating agent such as, for example, a drying powder, to the granules.

In one or more embodiments of the present invention, a round proppant material having a core comprising fly ash and clay, wherein the fly ash is the primary component by weight, provides a strong ceramic proppant that, because of the absence of bauxite and/or coatings, is more economical and can compete with frac sand.

In one or more embodiments of the present invention, a round proppant material having a core comprising fly ash, clay, and bauxite, wherein the fly ash is the primary component by weight, provides a proppant material that does not require a coating. The proppant may be manufactured by granulating the particles, drying the granules, sieving the granules and, prior to entering the kiln, adding a separating agent such as, for example, a drying powder, to the granules.

In one or more embodiments of the present invention, a round proppant material having a core comprising fly ash, clay, and bauxite, wherein the fly ash is the primary component by weight, provides a strong ceramic proppant that, because of the absence of bauxite coating, is more economical and can compete with frac sand.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A round proppant material comprising:
a core comprising fly ash and clay, wherein the fly ash is the primary component by weight; and
a separating agent applied to the core during manufacture.

2. The proppant of claim 1, wherein the core comprises about 90% fly ash and about 10% clay.

3. The proppant of claim 1, wherein an iron oxide content of the fly ash is 12% or less.

4. The proppant of claim 1, wherein an iron oxide content of the fly ash is about 7% or less.

5. The proppant of claim 1, wherein an iron oxide content of the fly ash is about 4% or less.

6. The proppant of claim 1, wherein the separating agent content of the proppant is about 10% or less.

7. A method of manufacturing a round proppant material comprising:
forming round granules comprising fly ash and clay, wherein the fly ash is the primary component by weight;
adding a separating agent to the round granules;
calcining the round granules at a temperature in a range between 900° C. and 1150° C.; and
sintering the round granules at a temperature in a range between 1050° C. and 1350° C.

8. The method of claim 7, wherein the round granules are sintered at a temperature in a range between 1150° C. and 1300° C.

9. The method of claim 7, wherein the round granules are sintered at a temperature in a range between 1200° C. and 1280° C.

10. The method of claim 7, wherein the adding of the dry powder occurs after calcining the round granules and before sintering the round granules.

11. A round proppant material comprising:
a core comprising fly ash, bauxite, and clay, wherein the fly ash is the primary component by weight; and
a separating agent applied to the core during manufacture.

12. The proppant of claim 11, wherein the core comprises about 70% fly ash, about 15% clay, and about 15% bauxite.

13. The proppant of claim 11, wherein an iron oxide content of the fly ash is 12% or less.

14. The proppant of claim 11, wherein an iron oxide content of the fly ash is about 7% or less.

15. The proppant of claim 11, wherein an iron oxide content of the fly ash is about 4% or less.

16. The proppant of claim 11, wherein the separating agent content of the proppant is about 10% or less.

17. A method of manufacturing a round proppant material comprising:
forming round granules comprising fly ash, bauxite, and clay, wherein the fly ash is the primary component by weight;
adding a separating agent to the round granules;
calcining the round granules at a temperature in a range between 900° C. and 1150° C.; and
sintering the round granules at a temperature in a range between 1050° C. and 1350° C.

18. The method of claim 17, wherein the round granules are sintered at a temperature in a range between 1150° C. and 1300° C.

19. The method of claim 17, wherein the round granules are sintered at a temperature in a range between 1200° C. and 1280° C.

20. The method of claim 17, wherein the adding of the dry powder occurs after calcining the round granules and before sintering the round granules.
